(19) United States
(12) Patent Application Publication
(10) Pub. No.: US 2002/0097686 A1
(43) Pub. Date: Jul. 25, 2002

(54) Long-range prediction of fading signals for WCDMA high speed downlink packet access (HSDPA)

(76) Inventor: Robert C. Qiu, Morris Plains, NJ (US)

Correspondence Address: MATHEWS, COLLINS, SHEPHERD & GOULD, PA, 100 THANET CR, SUITE 306, PRINCETON, NJ, 08540, US

(21) Appl. No.: 09/892,187

(22) Filed: Jun. 26, 2001

Related U.S. Application Data
(60) Provisional application No. 60/252,127, filed on Nov. 20, 2000.

(51) Int. Cl. H04J 1/16; H04L 1/00

(52) U.S. Cl. 370/252; 370/465; 370/477

(57) ABSTRACT

The present invention is an adaptive system, which supports higher peak data rate and throughput in digital wireless communications, compared with other non-adaptive systems. One embodiment of the invention consists of three parts: the Long Term Prediction system for fast fading DS/CDMA mobile radio channel; the fast feedback system to enable the adaptive transmission; and, new system blocks that are supported/enabled and changes in the existing 3GPP WCDMA system specifications.

### CROSS REFERENCES TO RELATED APPLICATIONS

This application claims the benefit of U.S. Provisional application Serial No. 60/252,127 filed on Nov. 20, 2000.

### FIELD OF THE INVENTION

This invention relates to the field of wireless digital communications, and more particularly to digital signal processing for such signals.

### BACKGROUND OF THE INVENTION

Wireless communications facilitates the delivery of information between the transmitter and the receiver without a physical wired connection. Such advantage translates to the freedom of mobility for the users and to the savings of wiring nuisance for the users. However, spectrum has become scarce resource as the usage of wireless communications for various applications becomes more popular. Therefore the efficiency of using spectrum presents challenges for the wireless industry. In order to maximize efficient spectrum utilization, various multiple access methods have been proposed to achieve the goal.

First generation cellular communications systems, Advanced Mobile Phone Services (AMPS) employed the Frequency Division Multiple Access (FDMA) method and provided voice communication services in the early days. Second generation cellular communications systems improved the spectrum efficiency by using more digital processing of signals and employed Time Division Multiple Access (TDMA) method in GSM and IS-136 systems and Code Division Multiple Access (CDMA) method in IS-95 systems. While second generation systems typically provide two to five times voice capacity over the first generation systems, data capabilities of second-generation systems are very limited.

A communication system where the transmitter has the side information feedback from receiver to transmitter was disclosed by Claude E. Shannon as early as in the 1950s. Channels with feedback from the receiving to the transmitting point are special case of a situation in which there is additional information available at the transmitter which may be used as an aid in the forward transmission system. Along with this line, a number of ideas have been presented which appeared to solve the problems in the fading channel. However, only recently the fading channel received a lot of attention due to the mobile wireless communications, particularly in the Code Division Multiple Access (CDMA) technology.

### SUMMARY OF THE INVENTION

The present invention is an adaptive communication system, which supports higher peak data rate and throughput in digital wireless communications, compared with other non-adaptive systems.

### BRIEF DESCRIPTIONS OF THE DRAWINGS

A more complete understanding of the present invention may be obtained from consideration of the following description in conjunction with the drawings in which:

FIG. 1 is a high-level block diagram illustrating the principle of Long-Range Prediction and its application;

FIG. 2 is a diagrammatic representation showing the Channel State Information (CSI) obtained using either time-multiplexed pilot symbols (transmitted in DPCCH) or code-multiplex pilot channel signals (transmitted in CPICH); and,

FIG. 3 shows a high-level block diagram of a WCDMA HSDPA system using Long-Range Prediction of Fast Flat Fading.

### DETAILED DESCRIPTION OF VARIOUS ILLUSTRATIVE EMBODIMENTS

This invention digital is related to signal processing and system design, and more particularly to a mobile communication system for adaptive transmission in the radio frequency fading channel to improve the system capacity. The present invention is an adaptive system, which supports higher peak data rate and throughput in digital wireless communications, compared with other non-adaptive systems.

One exemplary embodiment of the invention comprises three elements: the Long Term Prediction system for fast fading DS/CDMA mobile radio channel; the fast feedback system to enable the adaptive transmission; and new system blocks that are supported/enabled and changes in the existing 3GPP WCDMA system specifications.

Fading of wireless signals is a deterministic process. One of the fundamental difficulties for the IS-95-B and IS-2000 standards lies in the fact that it is difficult for long duration of the frame structure to support fast channel information feedback.

### Principle of Long-range Prediction

In WCDMA, several adaptive transmission techniques, including adaptive modulation and coding, power/rate control, antenna diversity, ARQ, and others, are used for adaptation to rapidly time variant fading channel conditions. Since the channel changes rapidly, the transmitter and receiver are usually not designed optimally for current channel conditions and thus fail to take advantage of the full potential of the wireless channel. By exploiting the time-varying nature of the wireless multi-path fading channel, all these adaptive schemes are trying to use power and spectrum more efficiently to realize higher bit-rate transmission without sacrificing the bit error rate (BER) performance.

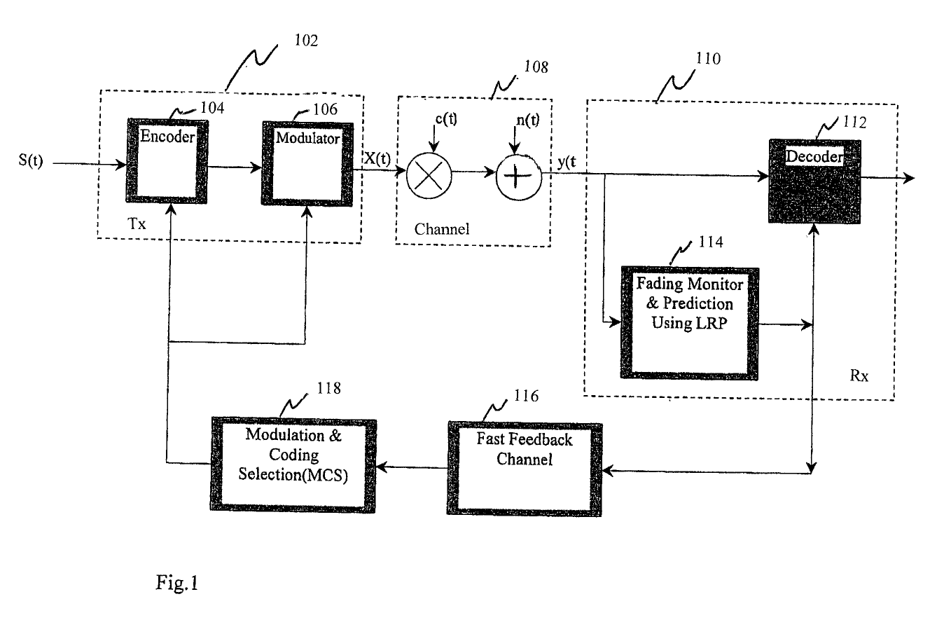

Referring to FIG. 1 there is shown a block diagram illustrating the principle of Long-Range Prediction and its application. Signal S(t) is coupled to a transmitter 102. The transmitter comprises an encoder 104, which is coupled to a modulator 106. The output of the transmitter 102 is X(t). Transmission channel 108 modifies the signal X(t) by multiplying the signal X(t) by the flat fading coefficient c(t) (as yet to be defined in Equation 1) and by the additive noise n(t), resulting in a modified signal y(t)=X(t) c(t)+n(t) which is detected by a receiver 110. The receiver 110 is comprised of a decoder 112 and a fading monitor & prediction using LRP section 114 which are coupled to the received signal y(t). The output of the fading monitor & prediction using LRP section 114 is coupled to the decoder 112 and a fast feedback channel 116 which is coupled to a modulation and coding selection (MCS) section 118. The output of the MCS section 118 is coupled to the encoder 104 and the modulator 106.

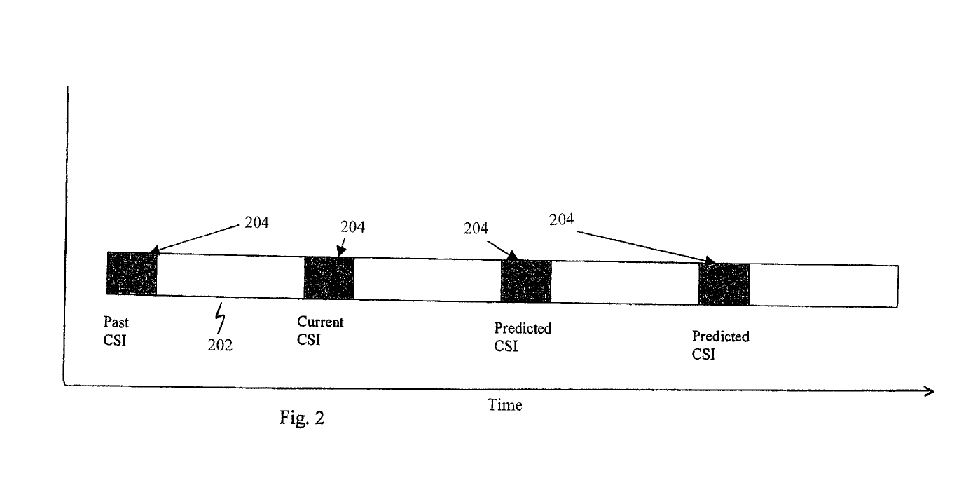

Referring to FIG. 2 there is shown a diagrammatic representation showing the Channel State Information (CSI) 202 obtained using either time-multiplexed pilot symbols (transmitted in DPCCH) or code-multiplex pilot channel signals (transmitted in CPICH) 204. To implement the adaptive transmission methods, the channel state information (CSI) must be available at the transmitter. CSI can be estimated at the receiver and sent to the transmitter via a feedback channel. Feedback delay, overhead, processing delay and etc are considered. For very slowly fading channels (pedestrian or low vehicle speed for most HSDPA applications), outdated CSI is sufficient for reliable adaptive system design. For faster speed, LRP is needed in order to realize the potential of adaptive transmission methods. These channel variations have to be reliably predicted at least several milliseconds (ms), or tens to hundreds of data symbols. Notice that one frame (15 slots) of WCDMA is 10 ms. The goal of LRP is to enable the adaptive transmission techniques.

The present invention utilizes prediction of future fading conditions to improve the performance of WCDMA, especially for HSDPA applications. The present invention is a WCDMA system paradigm that uses the mechanisms of prediction of future fading conditions. The present invention is equally well suited for use with other system design such as CDMA2000. Of particular importance is how the new system paradigm improves the WCDMA system performance, especially high-speed packet access.

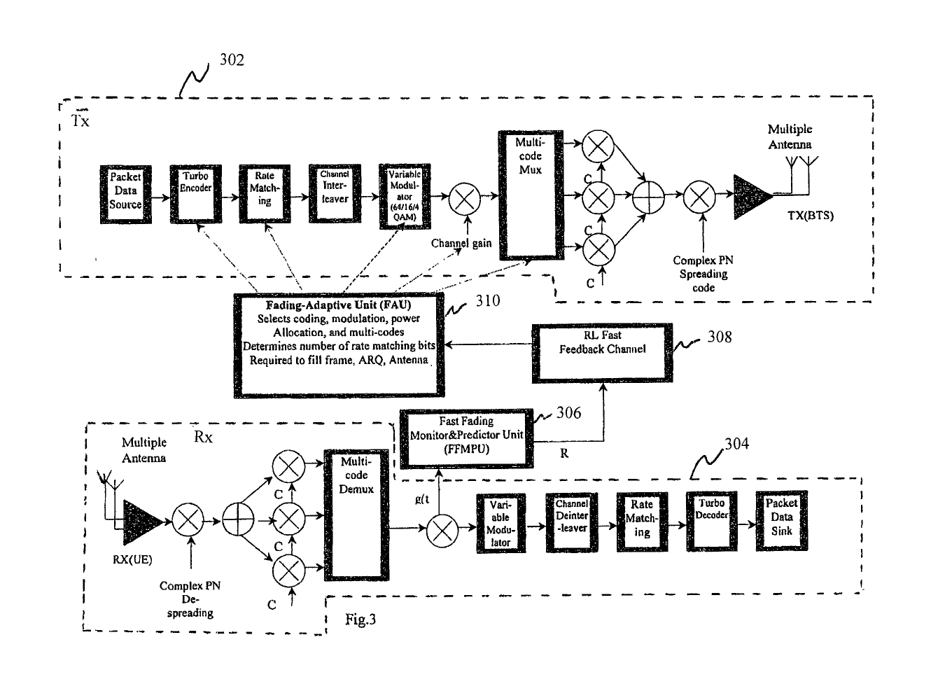

Referring to FIG. 3 there is shown a high-level block diagram of a WCDMA HSDPA system using Long-Range Prediction (LRP) of Fast Flat Fading. In addition to the traditional system blocks, transmitter 302 and receiver 304 found in WCDMA HSPDA [3GPP TR], new components including Fast Fading Monitor & Prediction Unit (FFMPU) 306, Reverse Link (RL) Fast Feedback Channel (RLFFC) 308, and Fading-Adaptive Unit (FAU) 310 are provided.

The FFMPU 306 is simultaneously monitoring the current and predicting the future fast multipath fading using LRP. There are several LRP algorithms (to be discussed below) available for practical implementation.

The RLFFC 308 feedbacks some measured parameters describing the channel fading conditions from the mobile user equipment 304 (UE) to the base station 302 (BTS). These parameters are measured in UE 304.

The FAU 310 makes decisions on some selection on coding rate, modulation level, power allocation, multi-codes, number of rate matching bits required to fill a frame, ARQ, antenna diversity, scheduling, cell site selection, and etc. The FAU 310 can exist either in UE or BTS, depending on the final implementation complexity.

The principle of FAU 310 is to adapt the selected system parameters to the rapidly changing fading channel conditions. The key feature of the system is the Long-Range Prediction ability of fading. Thus the transmitter 302 and receiver 304 have the accurate CSI parameters on future fading channel conditions by means of LRP. These CSI parameters include the maximum Doppler frequency shift. The availability of these forthcoming CSI parameters up to 15 slots/subframe in advance has made possible otherwise impossible new room in optimizing system design. Adaptation of the transmission parameters is based on the transmitter's perception of the channel conditions in the forthcoming time slots/subframes. Clearly, this estimation of future channel parameters can only be obtained by extrapolation of previous channel estimation called prediction. The channel characteristics have to be varying sufficiently slowly compared to the estimation interval.

In the present invention, the inclusion of the LRP mechanism improves the WCDMA HSDPA system performance including supporting higher data rate.

Adaptive Transmission Techniques used in Fading-Adaptive Unit (FAU)

The basic idea of adaptive modulation is to choose higher constellation size M of QAM (and therefore bit rate) for higher channel strength. Constant power and modulation size techniques suffer most BER degradation during deep fades. However fading channel spends most of the time outside deep fades. Thus adaptive modulation uses relatively high average constellation size (and bit rate) most of the time and avoid severe BER penalty by reducing the bit rate and using power efficient low modulation sizes (or turning off transmission entirely) during deep fades. The transmission load is shifted away from the deep fades and increases when the channel gets stronger. On the average, must faster bit rates relative non-adaptive techniques can be achieved without sacrificing the BER performance.

The basic idea of adaptive channel coding is to select a code with lower rate when the channel is going into fade, and a higher rate when the channel becomes stronger.

Punctured Turbo codes are used since they have superior performance and availability of a wide range of code rates without changing the basic structure of the encoder and decoder (codec).

For adaptive transmitter diversity, the channel power of each transmitter antenna is monitored at the receiver, and the antenna with strongest power is selected. The diversity gain depends on how to accurately estimate the downlink propagation path conditions. LRP can improve this estimation.

A critical fact for adaptive ARQ is that the transmission efficiency under flat Rayleigh fading conditions with smaller maximum Doppler frequency f_{d} is higher than that AWGN channel conditions because long error-free length is more probable under fald Rayleigh fading conditions with smaller f_{d} than under AWGN channel conditions due to burstness of the error sequence. This is one of reasons that justify the use of ARQ or Hybrid ARQ in HSDPA. This fact also implies that “knowing” f_{d} in advance of one future frame or future 10-15 slots/sub-frames, say, by means of LRP, seems to help the transmission efficiency using for a system using ARQ under flat Rayleigh fading channel conditions. When f_{d} increases, transmission efficiency decreases because error-free length becomes short with increasing f_{d}. Transmission efficiency depends on bit energy E_{b}/N₀.

Scheduling of resources benefits from the knowing the future fading CSI and tries to avoid the transmission when channel is not in good conditions. The technique of the present invention will help reduce the scheduling delay and improve the throughput.

Although space diversity is a very effective technique for compensating for rapid fading, it is helpless to compensate for log-normal fading or path loss due to distance. This requires so-called site diversity to obtain independent diversity paths by using plural base stations. In the case of Fast Cell selection, the UE selects the best cell every frame from which it wants to receive data on the HS-DSCH. HS-DSCH data is then transmitted to the UE from this cell only. UE can better select the best frame once UE knows the future fading CSI.

If the fading CSI is known then the use of multi-code can be adaptively adjusted.

Multiple Input and Multiple Output (MIMO) antennas seem to be sensitive to the fading CSI. The improved performance of LRP used for the fading CSI will definitely help MIMO antenna processing.

### LRP Algorithms in the FFMPU

LRP algorithms are known to those skilled in the art. A discussion of various algorithms can be found in LRP of Fading Signals by Alexandra Duel-Hallen, IEEE Signal Processing Magazine, May 2000, which is incorporated herein by reference as if set out in full.

### Signal Model

Consider a low-pass complex model of the received signal at the user equipment

r(t)=c(t)s(t)+I(t) Equation 1.

where c(t) is the flat fading coefficient (multiplicative), s(t) is the transmitted signal, and the I(t) includes the impact of the total interference resulting from the sum of M users, i.e.

$$I ( t ) = {\sum }_{t = l}^{M} {I}_{l} ( t ) . \qquad \text{Equation 2}$$

For the HSDPA case, we are interested in the downlink where the user equipment makes the measurement. I(t) can be modeled additive white Gaussian noise (AWGN). Let the transmitted signal at the base station be

$$s ( t ) = {\sum }_{k} {b}_{k} g ( t - kT ) . \qquad \text{Equation 3}$$

where bₖ is the data sequence modulated using M-PSK or M-QAM, g(t) the BTS smitter pulse shape, and T the symbol delay. At the output of the matched filter and sampler, the discrete-time system model is given by rₖ=bₖcₖ+zₖ, where cₖ is the fading signal c(t) sampled at the symbol rate, and zₖ is the discrete AWGN process I(t). In general, the sampling rate represented by subscript n differs from the data rate represented by k throughout this paper. Usually, c(t) and cₖ can be modeled as a correlated complex Gaussian random processes with Rayleigh distributed amplitudes and uniform phases. Using the pilot-aided signals in WCDMA, the receiver can correctly detect the symbol bₖ. Then by multiplying the received samples by the conjugate of bₖ, the modulation can be removed, yielding

rₖ=cₖ+z₁ₖ Equation 4.

where z₁ₖ is still an AWGN with the same variance as zₖ.

The derivation of this prediction method is based on a physical description of the fading signal. In this section, the mathematical description of the interference pattern from the point of view of the mobile is primarily considered. The fading coefficient at the receiver is given by a sum of N Doppler shifted signals

$$c ( t ) = {\sum }_{n = 1}^{N} {A}_{n} {e}^{{j2πf}_{n} l + {φ}_{n}} . \qquad \text{Equation 5}$$

where (for the n-th scatterer) Aₙ is the amplitude, fₙ is the Doppler frequency, and ^{φ}ₙ is the phase. The Doppler frequency is given by

fₙ=f_{c}(v/c) cos(αₙ) Equation 6.

where f_{c} is the carrier frequency, v is the speed of mobile, c is the speed of light, and αₙ is the incident angle relative to the mobile's direction. Due to multiple scatterers, the fading signal varies rapidly for large vehicle speeds and undergoes “deep fades”.

The fading signal cₖ in Equation 4 is predicted by decomposing it in terms of the N scattered components. If the parameters Aₙ, fₙ, and αₙ, in Equation 5 for each of the scatterers were known and remained constant, the signal could be predicted indefinitely. In practice, they vary slowly and are not known a priori. Assume that the propagation characteristics will not change significantly during any given data block. Therefore, these parameters are modeled as approximately constant or change slowly varying for the duration of the data block. To predict the fading signals, spectral estimation followed by linear prediction and interpolation is employed. Estimation of the power spectral density of discretely sampled deterministic and stochastic processes is usually based on procedures employing the Discrete Fourier Transform (DFT). Although this technique for spectral estimation is computationally efficient, there are some performance limitations of this approach. The most important limitation is that of frequency resolution. The frequency resolution Δf=1/fₛ of the N-point DFT algorithm, where fₛ is the sampling frequency, limits the accuracy of estimated parameters. These performance limitations cause problems especially when analyzing short data records.

Many alternative Spectral Estimation Techniques have been proposed within the last three decades in an attempt to alleviate the inherent limitations of the DFT technique. What follows are several practical alternative embodiments, considering the specific application to HSDPA.

### Maximum Entropy Method (MEM)

The Maximum Entropy Method (MEM) for the prediction of the fast fading signal, is also known as the All-poles Model or the Autoregressive (AR) Model and is widely used for spectral estimation. The reason this technique was chosen is that the MEM has very nice advantage of fitting sharp spectral features as in the fading channel due to scatterers (Equation 5). Furthermore, MEM is closely tied to Linear Prediction (LP), which is used to predict future channel coefficients. Using MEM, the frequency response of the channel is modeled as:

$$H ( z ) = \frac{1}{1 - {\sum }_{j = 1}^{p} {d}_{j} {z}^{j}} . \qquad \text{Equation 7}$$

This model is obtained based on a block of samples of the fading process. Note that the samples have to be taken at least at the Nyquist rate, which is twice the maximum Doppler frequency, fd. Moreover, the accuracy of the model depends on the number of samples in the given block. The dj coefficients are calculated from the poles of the power spectral density. The dⱼ coefficients in Equation 7 are also the linear prediction coefficients. The estimates of the future samples of the fading channel can be determined as:

$${\hat{c}}_{n} = {\sum }_{j = 1}^{p} {d}_{j} {c}_{n - j} . \qquad \text{Equation 8}$$

Thus, ĉₙ is a linear combination of the values of cₙ over the interval [n-p, n-1]. Since actual channel coefficients are not available beyond the observation interval, earlier sampling estimates ĉₙ₋ⱼ, can be used instead of the actual values cₙ₋ⱼ in Equation 8 to form future estimates ĉₙ, or the samples can be updated adaptively below.

Note that the channel sampling rate utilized for LP is much lower than the symbol rate, 1/T. Therefore, to predict the fading coefficients, cₖ in Equation 4, associated with transmitted symbols, interpolation is employed as discussed. In this interpolation process, four consecutively predicted channel coefficients are interpolated by a Raised Cosine (RC) filter to generate estimates of the fading coefficients, ĉₖ, between two adjacent predicted samples at the data rate.

Interpolation is preferred to oversampling of the fading channel to obtain the fading coefficients at the data rate. If oversampling is employed, MEM will require a larger number of poles and consequently the complexity will increase.

The prediction method can be combined with tracking and transmitter signal power adjustment. The channel samples taken during the observation interval are sent to the transmitter, which applies linear prediction to compute the coefficients and interpolates to produce predicted fading values at the data rate. Note that this feedback is not going to introduce significant delay since the sampling rate is much lower than the data rate. Then, the transmitter sends the data bits, bk, by multiplying them with the inverse of the ĉₖ values. While this is not the optimal method for transmission over the time varying channel, it still achieves significant gains relative to the case when power compensation is not employed at the transmitter. At the output of the matched filter and sampler, the new modified discrete-time received signal is given by

$${y}_{k} = \frac{{c}_{k}}{{\hat{c}}_{k}} {b}_{k} + {z}_{k} . \qquad \text{Equation 9}$$

where zₖ is discrete-time AWGN. Define aₖ=

$$\frac{{c}_{k}}{{\hat{c}}_{k}} .$$

As the prediction gets better, the value of aₖ goes to 1. When aₖ=1, i.e., perfect estimation, our fast fading channel becomes the AWGN channel.

The Least Mean Squares (LMS) adaptive algorithm is employed to track the variations in aₖ. Given the received signal (Equation 9), the LMS algorithm is performed at the data rate as

ãₖ₊₁=ãₖ+μbₖ(yₖ−\tilde{y}ₖ) Equation 10.

where μ is the step size, \tilde{y}ₖ=ãₖbₖ. This tracking is employed to perform coherent detection at the receiver, as well as to update the estimate of the fading at the sampling rate. The new fading sample is computed as \tilde{c}ₖ=ãₖĉₖ and send back to the transmitter at the sampling rate. The transmitter uses this updated estimates in (8) to predict future fading values, rather than relying on previous estimates. This adaptive algorithm enables us to reduce the prediction error described earlier and to approximate the performance of the AWGN channel.

### Root-MUSIC

Root-MUSIC is especially useful, in that it has two desirable features: high resolution and no need for spectral peak finding.

A K-by-K sample correlation matrix can be constructed from output data in Equation 4, i.e.,

R=G*G^{H} Equation 11.

Where G is the forward-backward data matrix constructed from output data in Equation 4. Assuming the number of sinusoids P (typically P=8−10) is known, then the noise subspace is obtained as Span{Vₙ},=[Vₚ₊₁Vₚ₊₂V_{K}] Where Vₙ consists of the K-P smallest eigenvectors of R. Let Q=VₙVₙ^{H} and

$${c}_{l} = {\sum }_{k = 1}^{K - i} {Q}_{k , k + 1} and {c}_{- 1} = {\sum }_{k = 1}^{K - i} {Q}_{k + i , k}$$

for i=0, 1, 2, . . . , K−1 Note that c*₁=c₋₁, and forms the polynomial equation c_{-K+1}+c_{-K+2}z⁻¹+ . . . +c₀z^{-K+1}+ . . . +c_{K-1}z^{-2(K-1)}=0. Solving this equation gives 2(K−1) roots having reciprocal symmetry with respect to the unit circle. Denote the P roots that outside and also nearest to the unit circle as z₁, z₂, . . . zₚ. Then the frequency estimates are given by fᵢ=arg(z₁)/2π, i=1, 2, . . . , P, where arg(z₁) denotes the principal argument (in radians) of z₁. Root-MUSIC needs to know the number of the sinusoids a priori. So-called root location constraints can be used to avoid this problem.

Once the frequency estimates have been obtained, the complex amplitudes E₁=Aᵢe^{1φ1} can be found by linear least square (LS) fit of the following matrix-vector equation A E=[a₁ a₂ . . . aₚ] E=g, where a₁=[1 e_{j2πfi} . . . e_{j2πfiN}]^{T} for i=1, 2, . . . , P, E=[E₁ E₂ . . . Eₚ]^{T} is the complex vector to be found, and g=[g(0) g(1) . . . g(N)]^{T}. The LS solution of the above equation is given by Ê=A^{#}g, where A^{#}=(A^{H}A)⁻¹-A^{H} is the pseudo inverse of A. In this way, the parametric sinusoidal model for the fading process is obtained. Fading prediction can be done by this method.

### MMSE AR Method

MMSE prediction of the flat fading channel is used for the AR model.

### ESPRIT

### Performance Bounds

The performance of the method is described as following. For a^{k}=1, i.e., perfect estimation, the average probability of bit error for BPSK is given by

Pₑ=Q(\sqrt{2γ_{b}}) Equation 12.

where γ_{b} is the SNR and Q(x) is defined as

$$Q ( x ) = \frac{1}{\sqrt{2 π}} {\int }_{x}^{∞} {e}^{- {t}^{2} / 2} ⅆ t .$$

. Since this performance is achieved with perfect prediction and this curve forms the lower bound for our system. If there is no correction at the transmitter, the received signal is given by Eq. (4). Since cₖ is approximately Rayleigh, the average probability of bit error for the Rayleigh fading channel is found as

$${P}_{e} = \frac{1}{2} ( 1 - \sqrt{\frac{{γ}_{b}}{1 + {γ}_{b}}} ) . \qquad \text{Equation 13}$$

Equation 13 forms the upper bound of the proposed method. The expected realistic performance should lie between the upper bound and lower bound.

For the QAM similar curves are obtained. For square-QAM, carrier regeneration using pilot-aided signal is essential. Gray encoding with absolute phase coherent detection can be applied. The BER for Gray-encoded 16QAM and 64QAM is, respectively, for AWGN given by

$${P}_{e16QAM} = \frac{3}{8} erfc ( \sqrt{\frac{2}{5} {γ}_{b}} ) - \frac{9}{64} {erfc}^{2} ( \sqrt{\frac{2}{5} {γ}_{b}} ) \\ {P}_{e64QAM} = \frac{7}{24} erfc ( \sqrt{\frac{1}{7} {γ}_{b}} ) - \frac{49}{384} {erfc}^{2} ( \sqrt{\frac{1}{7} {γ}_{b}} ) . \qquad Equation 14$$

For Rayleigh fading channel, it is seen that

$${P}_{e16QAM} = \frac{3}{8} [ 1 - \frac{1}{\sqrt{1 + \frac{5}{2 {γ}_{b}}}} ] \\ {P}_{e64QAM} = \frac{7}{24} [ 1 - \frac{1}{\sqrt{1 + \frac{7}{{γ}_{b}}}} ] . \qquad Equation 15$$

Numerous modifications and alternative embodiments of the invention will be apparent to those skilled in the art in view of the foregoing description. Accordingly, this description is to be construed as illustrative only and is for the purpose of teaching those skilled in the art the best mode of carrying out the invention. Details of the structure may be varied substantially without departing from the spirit of the invention and the reserved.

For example, although the inventive concept was illustrated herein as being implemented with discrete functional building blocks, the functions of any one or more of those building blocks can be carried out using one or more appropriately programmed processors, e.g., a digital signal processor. It should be noted that the inventive concept is equally well suited for other wireless systems.

In one exemplary embodiment, the present invention supports higher peak data rate and throughput, compared with other non-adaptive systems. In yet another exemplary embodiment, the present invention can be supported by the existing 3GPP WCDMA system structure, particularly the frame/slot structure. The present invention is equally valid for use with other similar systems where the frame structure supports the fast feedback from receiver to transmitter point. Once the principle of fading adaptation is established, each related part of the mobile communications system can be improved.

While various terms and abbreviations are defined in this application, and would be clearly understood to and understood by one skilled in the art, attention is drawn to the above referenced publications for further details and descriptions.

We claim:

1. A method for long long-range prediction of fading signals for high speed downlink packet access from a base station to a mobile unit comprising the steps of:
generating a prediction of fast flat fading;
selecting transmitter parameters as a function of the prediction of fast flat fading.

2. The method as recited in claim 1 wherein the transmitter parameters includes coding rate.

3. The method as recited in claim 1 wherein the transmitter parameters includes modulation level.

4. The method as recited in claim 1 wherein the transmitter parameters includes power allocation.

5. The method as recited in claim 1 wherein the transmitter parameters includes multi-codes.

6. The method as recited in claim 1 wherein the transmitter parameters includes number of rate matching bits required to fill a frame.

7. The method as recited in claim 1 wherein the transmitter parameters includes ARQ.

8. The method as recited in claim 1 wherein the transmitter parameters includes cell site selection.

9. The method as recited in claim 1 wherein the step of generating a prediction of fast flat fading further comprises uses maximum entropy method.

10. The method as recited in claim 1 wherein the step of generating a prediction of fast flat fading further comprises uses Root-MUSIC method.

11. The method as recited in claim 1 wherein the step of generating a prediction of fast flat fading further comprises ues MMSE AR method.

12. An apparatus for long long-range prediction of fading signals for high speed downlink packet access from a base station to a mobile unit comprising:
a generating unit for predicting fast flat fading; and,
a fading adaptive unit for selecting transmitter parameters as a function of the prediction of fast flat fading.

13. The apparatus as recited in claim 12 wherein the transmitter parameters includes coding rate.

14. The apparatus as recited in claim 12 wherein the transmitter parameters includes modulation level.

15. The apparatus as recited in claim 12 wherein the transmitter parameters includes power allocation.

16. The apparatus as recited in claim 12 wherein the transmitter parameters includes multi-codes.

17. The apparatus as recited in claim 12 wherein the transmitter parameters includes number of rate matching bits required to fill a frame.

18. The apparatus as recited in claim 12 wherein the transmitter parameters includes ARQ.

19. The apparatus as recited in claim 12 wherein the transmitter parameters includes cell site selection.

20. The apparatus as recited in claim 12 wherein the generating unit uses maximum entropy for predicting fast flat fading.

21. The apparatus as recited in claim 12 wherein the generating unit uses Root-MUSIC for predicting fast flat fading.

22. The apparatus as recited in claim 12 wherein the generating unit uses MMSE AR for predicting fast flat fading.
